(19) United States
(12) Patent Application Publication
(10) Pub. No.: US 2002/0121723 A1
(43) Pub. Date: Sep. 5, 2002

(54) Method of manufacturing a honeycomb structure that is to be affixed to an automobile interior component at a desired location to allow impact standards to be met

(76) Inventors: Darius J. Preisler, Macomb, MI (US); John F. Murphy, Imlay City, MI (US)

Correspondence Address: WELSH & KATZ, LTD, 120 S RIVERSIDE PLAZA, 22ND FLOOR, CHICAGO, IL, 60606, US

(21) Appl. No.: 09/797,442

(22) Filed: Mar. 1, 2001

(51) Int. Cl. B29C 39/02

(52) U.S. Cl. 264/138; 264/320

(57) ABSTRACT

A method for manufacturing a honeycomb structure that is to be affixed to a desired location on an automobile interior component is disclosed. A mold half is formed with an shape defining cavity that is contoured to have generally the same as the shape of one side of the honeycomb structure that is to be formed. A plurality of vertically indexed straws that, include a central core formed from a first thermoplastic material having a relatively high melting point and an outer layer of second thermoplastic material that has a relatively low melting point, are placed in contact with the shape defining cavity of the mold. In order to form the honeycomb structure, the mold is heated to a temperature that melts the second thermoplastic material but does not melt the first thermoplastic material, thereby allowing the indexed straws to be bonded together and form one side of the honeycomb structure. A cutting utensil is then used to cut the straws and create a honeycomb structure that is to be affixed to an automobile interior component. In one embodiment, the cut in the indexed straws that is made by the cutting utensil creates the same shape in the indexed straws as that of the shape defining cavity of the mold.

### FIELD OF THE INVENTION

The present invention generally relates to automobile interior components and, more particularly, to a method for manufacturing a honeycomb structure that is to be affixed to an automobile interior component at a desired location to allow certain impact standards to be met.

### BACKGROUND OF THE INVENTION

U.S. Pat. No. 5,683,782 discloses a process for producing a thermoplastic sandwich material that includes a honeycomb structure. Referring to FIG. 1 of U.S. Pat. No. 5,683,782, a greatly enlarged sectional representation of a honeycomb segment with a cover layer is shown. In accordance with the invention disclosed in this patent, a thermoplastic sandwich material is made from two outer reinforced thermoplastic skins with a cellular core at the center that is molded by a thermocompression process. The skins are formed from polypropylene with continuous glass mats or are formed by woven glass with polypropylene fibers. The content of U.S. Pat. No. 5,683,782 is incorporated by reference into this application as if fully set forth herein.

Thermoplastic sandwich materials such as those disclosed in U.S. Pat. No. 5,683,782 have been utilized in a variety of different applications. For example, U.S. patent application Ser. No. 09/451,970, filed Nov. 30, 1999 discloses a method for molding an impact resistant automotive part such as a bumper beam. A thermoplastic reinforced fiber structure at least partially forms a pair of attachment portions of the automotive part and continuously extends between the attachment portions to link the attachment portions. The content of the Ser. No. 09/451,970 patent application is incorporated by reference into this application as if fully set forth herein.

In another example, U.S. patent application Ser. No. 09/445,356, filed Dec. 10, 1999 discloses a method of making a composite panel that has a sandwich structure and that is provided with a hinge. The panel comprises a stack that includes at least one first skin of a reinforced thermoplastic material and a second skin of a thermoplastic material. The panel is formed by preheating the first and second skins to a softening temperature, and then pressing the stack of skins at a pressure that lies in a predetermined range. The content of the Ser. No. 09/445,356 patent application is incorporated by referenced into this application as if fully set forth herein.

Yet another exemplary use of thermoplastic sandwich material is disclosed in U.S. patent application Ser. No. 09/485,142, filed Feb. 4, 2000. This application discloses a method of making a reinforced composite panel of the sandwich type having a cellular-core. The content of the Ser. No. 09/485,142 application is incorporated by reference into this application as if fully set forth herein.

U.S. patent application Ser. No. 09/525,346, filed Mar. 15, 2000 discloses the utilization of thermoplastic sandwich material in a certain application. In particular, this application discloses a method and system for co-molding a thermoplastic material with a thermoplastic sandwich material to form a thermoplastic sandwich article. The article has a thermoplastic inner portion. The content of Ser. No. 09/525,346 patent application is incorporated by reference into this application as if fully set forth herein.

U.S. patent application entitled “Method and System For Molding Thermoplastic Sandwich Material and Deep-Drawn Article Produced Thereby,” filed Mar. 15, 2000 discloses a method and system for molding a thermoplastic sandwich material to form a deep-drawn article. In particular, an inner portion of a blank of thermoplastic sandwich material is forced into a female die along a vertical axis to form a deep-drawn article. A step of clamping may be performed at a plurality of spaced outer portions of the blank immediately adjacent the female die. The content of the above-referenced “Method and System” patent application is incorporated by reference into this application as if filly set forth herein.

As discussed above, thermoplastic sandwich materials are being used in a variety of different automobile applications. It should be noted that typical automobiles comprise a hard steel frame body which forms the skeleton of the car. The hard steel frame body is designed to meet various strength requirements necessary to protect the vehicle occupant from injury in a collision. To provide the interior of the car with an aesthetically pleasing appearance, automobiles are designed with interior components such as a dashboard, pillars, headliners, consoles and the like.

In the event of a vehicle collision, an occupant may be injured if he or she comes into contact with the automobile interior component that typically is rigidly connected to the hard frame body inside of the vehicle. To protect the occupant from the hard frame structure, a number of governmental regulations regarding safety requirements, such as the head impact collision requirement FMUSS201, have been promulgated. A number of automobile interior components that currently are on the market do not satisfy these requirements.

### BRIEF SUMMARY OF THE INVENTION

It is desirable to provide a method of manufacturing a honeycomb structure that is to be affixed to an automobile interior component at a desired location to allow safety requirements such as, for example, head impact collision standards to be met. In accordance with one aspect of the present invention disclosed and claimed herein, a mold half is formed with an shape defining cavity that is contoured to have generally the same shape as the shape of one side of the honeycomb structure that is to be formed. A plurality of straw members, that include a central core formed from a first thermoplastic material having a relatively high melting point and an outer layer of second thermoplastic material that has a relatively low melting point, are indexed into and placed in contact with the shape defining cavity of the mold.

In order to form the honeycomb structure, the mold is heated to a temperature that melts the second thermoplastic material but does not melt the first thermoplastic material, thereby bonding the indexed straws together. This forms one side of the honeycomb structure. A cutting utensil is then used to cut the bonded straws and create a honeycomb structure that is to be affixed to an automobile interior component. In accordance with a further aspect of the present invention disclosed and claimed herein, the cut creates the same shape in the indexed straws as that of the shape defining cavity of the mold.

Providing such an automobile interior component and a method for manufacturing the same provides a number of distinct advantages, including the following. First, manufacturing a honeycomb structure in the above-described manner allows the honeycomb structure to have any desired shape for any desired application. In one example, automobile interior components can be made to satisfy safety requirements such as, for example, head impact collision standards. Second, the honeycomb structures can be manufactured in an inline process together with automobile interior components that typically are formed with a molding process such as, for example, an injection molding technique.

Other features and advantages of the invention will become apparent from the description that follows.

### BRIEF DESCRIPTION OF THE DRAWINGS

The objects and advantages of the present invention will become more readily apparent to those of ordinary skill in the relevant art after reviewing the following detailed description and accompanying drawings, wherein:

FIG. 1 is a schematic representation of a top view of a van that illustrates a number of automobile interior components that include certain aspects of the present invention disclosed herein;

FIG. 2 is a front view of the B pillar component 24 shown in FIG. 1;

FIG. 3 is a rear view of the B pillar component 24 shown in FIGS. 1 and 2;

FIG. 4 is a rear view of the B pillar component 24, similar to FIG. 3,

illustrating honeycomb structures 60 and 62;

FIG. 5A is a bottom, perspective view of honeycomb structure 60; and

FIG. 5B is a top, perspective view of the honeycomb structures 60 and 62 shown in FIG. 4; and

FIG. 6 is a side, schematic view of a mold 90 that is used to form automobile interior components in accordance with certain aspects of the present invention;

FIG. 7A is a top view of a plurality of separate straw members 130 that are indexed into a shape defining cavity of a mold;

FIG. 7B is a sectional view of a mold half 94 that includes a shape defining cavity 95 in which a plurality of straws 130 are disposed;

FIG. 7C is top view of a plurality of straw members 130 that have been bonded together to form a unitary structure;

FIG. 8 is a sectional view of a mold half 94, similar to FIG. 7B, showing a cut line 97 that allows a honeycomb structure 97 to be formed; and

FIG. 9 is a section view of the honeycomb structure 99 shown in FIG. 8.

### DETAILED DESCRIPTION OF THE INVENTION

While the present invention is susceptible of embodiment in various forms, there is shown in the drawings a number of presently preferred embodiments that are discussed in greater detail hereafter. It should be understood that the present disclosure is to be considered as an exemplification of the present invention, and is not intended to limit the invention to the specific embodiments illustrated. It should be further understood that the title of this section of this application (“Detailed Description Of The Invention”) relates to a requirement of the United States Patent Office, and should not be found to be limiting to the subject matter disclosed herein.

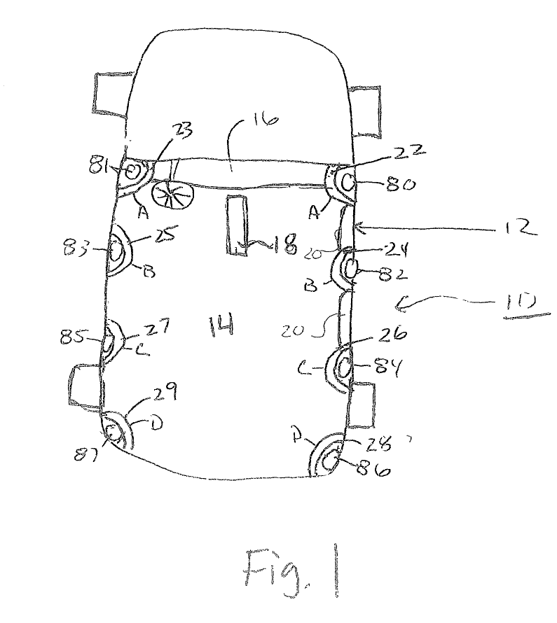

Referring now to FIG. 1, there is shown a schematic representation of a van 10 having a frame body 12. The frame body 12 includes upright portions 80-87, which extend from the main portion of the frame body 12 to a roof portion (not shown). The frame body 12 defines an interior 14 in which various automobile interior components are mounted. In the illustrated embodiment of the invention, interior 14 includes a dashboard 16, an interior console 18, side paneling 20, and pillars 22-29. It also should be understood that the present invention is applicable in other automotive applications such as, for example, in a headliner application (not shown). In the illustrated embodiment, four sets of pillars (A, B, C, and D) are shown. The pillars are mounted to cover the corresponding uprights 80-87 of the frame body 12.

The A, B, C, and D pillars are coupled to corresponding upright portions of the frame body 12. The A pillars are coupled to a corresponding first upright portion 80 and 81. The B pillars are coupled to corresponding second upright portions 82 and 83 that are located in a mid-portion of the vehicle, behind the front-side window. The C pillars are coupled to corresponding third upright portions 84 and 85 that are located behind the B pillar, near the rear portion of the vehicle. The D pillars are coupled to corresponding fourth upright portions 86 and 87 at the rear of the van. It should be understood that the number uprights (and pillars) vary in accordance with the general size of the vehicle.

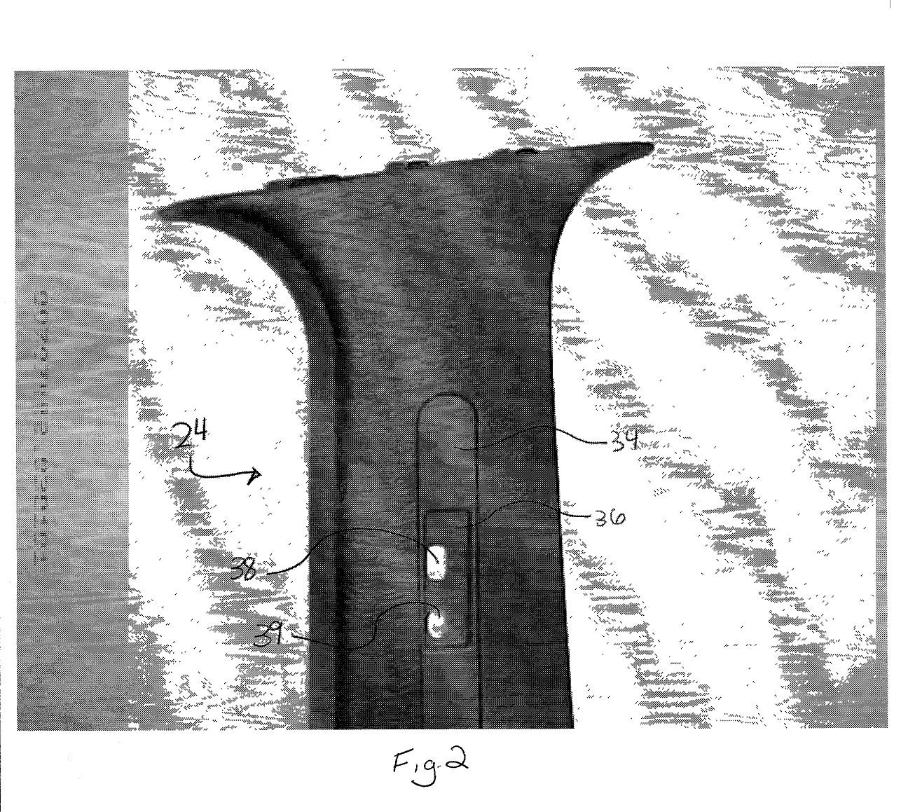

Referring to FIG. 2, a front view of the B pillar 24 (FIG. 1) is shown. The B pillar 24 includes a sliding mechanism 34 that is configured to receive a shoulder strap from a seat belt assembly (not shown). The sliding mechanism 34 has a movable slot 36 with plural holes 38 and 39 defined therein. In the illustrated embodiment of the invention, the sliding mechanism 34 is in operative connection to the B pillar 24 and slidably moves with respect to the B pillar 24. By manipulating the mechanism 34, the orientation of the seatbelt with respect to the B pillar 24 is varied into several positions.

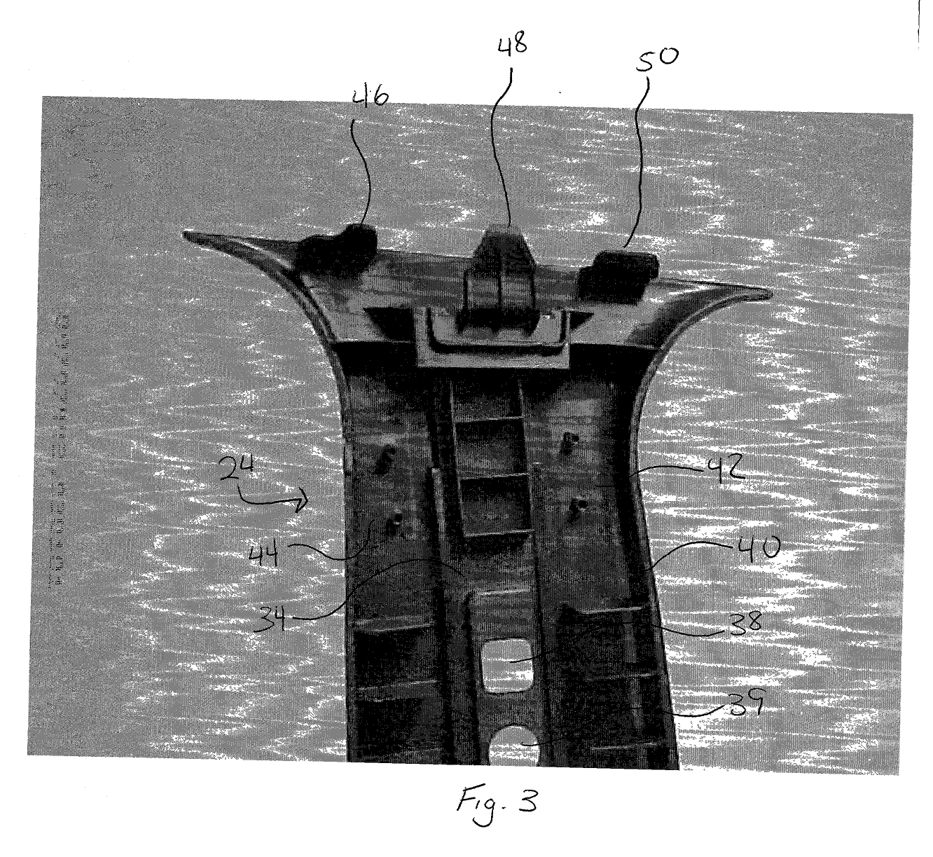

Referring now to FIG. 3, a reverse side view of the B pillar 24 showing an adjacent interior shell portion 40 is shown. As shown, interior shell portion 40 is configured to receive a honeycomb structure or like resilient material as discussed in greater detail hereafter to allow the B pillar to satisfy certain safety requirements such as, for example, head impact requirements. The B pillar 24 has adjacent dual mounting surfaces 42 and 44. Sliding mechanism 34 is disposed between the dual mounting surfaces 42 and 44. The pillar 24 includes fasteners 46, 48, and 50 that are used to securely snap the pillar 24 into flush connection with the van frame body's upright portion (not shown).

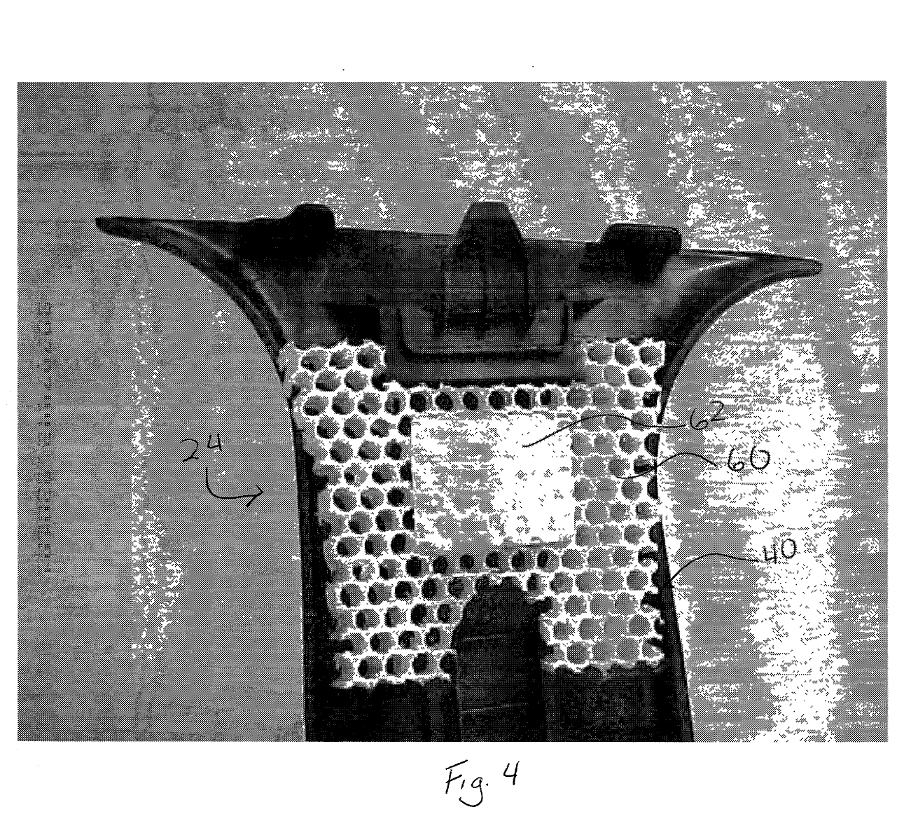

Referring now to FIG. 4, a rear side view of B pillar 24 is shown. Honeycomb structures 60 and 62 are affixed to the adjacent interior shell portion 40 of B pillar 24 after the B pillar 24 is formed. In accordance with this aspect of the invention, a mechanical means such as, for example, a gluing or press-fit technique is used to establish the connection.

In the illustrated embodiment of the invention, honeycomb structures 60 and 62 are glued together to form one unitary structure. However, it should be understood that the honeycomb structures 60 and 62 also can be formed in a one-piece configuration. In the illustrated embodiment of the invention, the honeycomb structure 60 is configured to be mounted on the B pillar 24 and a corresponding section of the automobile frame to allow the B pillar 24 to meet certain safety requirements such as, for example, head impact collision requirements as discussed in greater detail hereafter.

In the illustrated embodiment of the invention, one surface of the honeycomb member 60 is mechanically affixed or glued to the interior mounting face 40 of the B pillar 24. When the B pillar 24 is fastened to the vehicular frame, the exterior surface of honeycomb structures 60 and 62 are placed in contact with the corresponding upright portion of the vehicle. Thus, a unitary connection is established between the upright portion of the vehicle, the honeycomb structures 60 and 62, and the B pillar 24. The honeycomb structures 60 and 62 thereby provide the B pillar with certain physical characteristics so as to satisfy certain safety standards such as, for example, head impact collision standards.

The shape and configuration of the honeycomb structures 60 and 62 are determined in accordance with the shape of the exterior shell portion 40 of the B pillar 24 to which they are affixed. As shown in FIG. 4, the honeycomb structures 60 and 62 are affixed flush upon the inside of the mounting surface and spans the general width of the mounting surface 40.

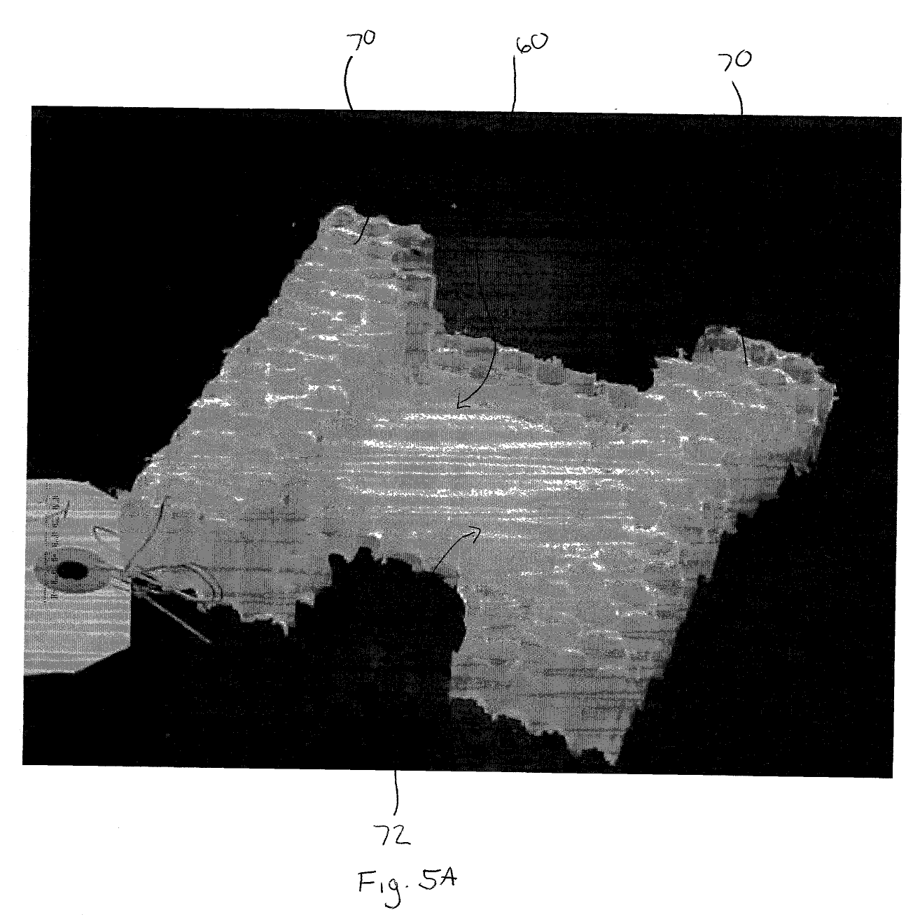

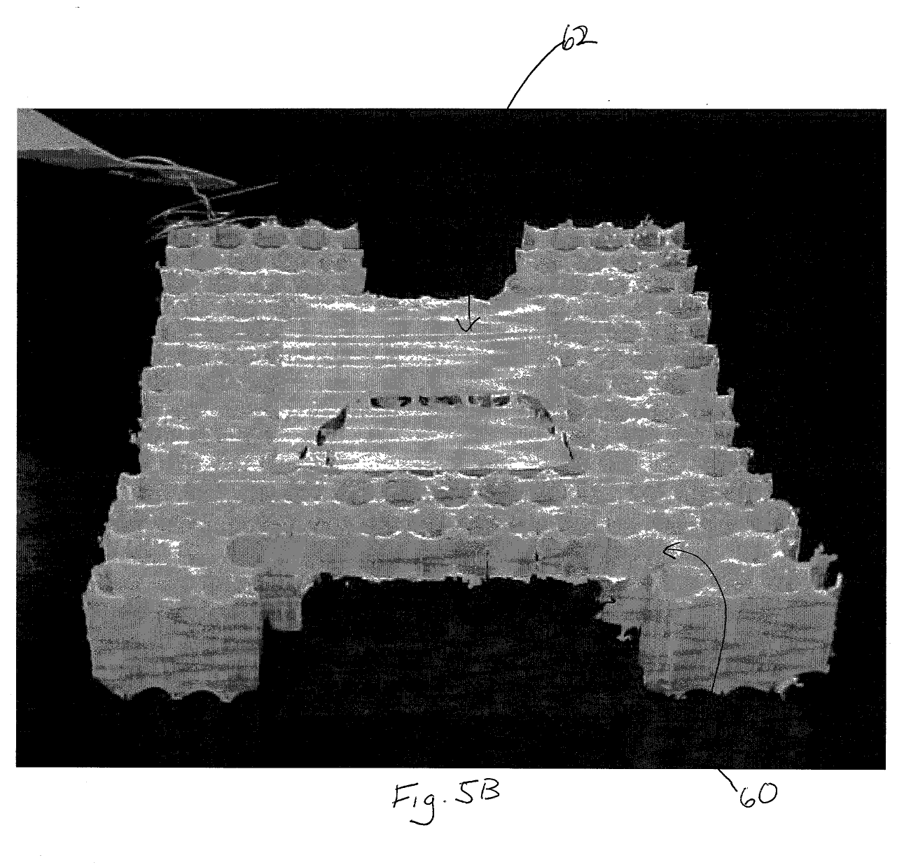

Referring to FIG. 5A, a bottom, perspective view of honeycomb structure 60 is shown. In the illustrated embodiment of the invention, the bottom surface of the honeycomb structure 60 that is affixed to the B-pillar 24 includes a channel 72 that allows the sliding mechanism of the seat belt assembly (not shown) to be moved by the occupant of a vehicle without resistance. Honeycomb structure 60 also includes two mounting portions 70 that are affixed to the mounting surfaces 42 and 44 that are defined on B pillar 24 (FIG. 3). It should be understood that, in accordance with the teachings of the present invention, the shape of bottom surface of honeycomb structure 60 is defined in accordance with the type of automobile interior component that is being used, as well as any other automobile components that are located in close proximity to the honeycomb structure such as air conditioning ducts, electrical conduits, and the like.

Referring to FIG. 5B, a top, perspective view of the honeycomb structures 60 and 62 are shown. In the illustrated embodiment of the present invention, the upper surfaces of honeycomb structures 60 and 62 generally correspond to the portion of the automobile frame to which they are connected so that the surface area of contact therebetween is generally maximized.

Various methods for manufacturing automobile interior parts by insert molding are disclosed, for example, in U.S. Pat. Nos. 6,180,207, 6,132,662 and 6,158,764. In accordance with certain teachings of these patents, a plastic preform part is inserted into a mold cavity of an injection mold. Thereafter, a thermoplastic elastomer or molten resin is injected into the mold cavity of the injection mold to generate a substrate of the preform part. The resulting part is cooled and removed from the mold. The contents of the above-referenced patents are incorporated by reference into this application as if fully set forth herein.

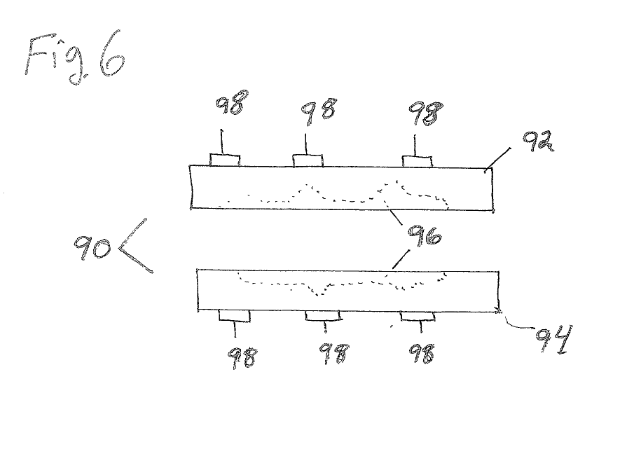

FIG. 6 is a side view of a exemplary mold 90 that is suitable for use in connection with aspects of the present invention disclosed herein. In particular, mold 90 can be utilized to manufacture automobile interior components that satisfy certain safety requirements such as, for example, head impact collision requirements. In accordance with this aspect of the present invention, a honeycomb structure is inserted into the article defining cavity of a mold during the molding process. For example, mold 90 is used to manufacture automobile interior components such as, for example, B pillar 24 that is shown in FIG. 1. Also, for example, the honeycomb structure is formed to have a desired shape as discussed above with reference to FIGS. 1-5B. However, it should be understood that mold 90 can be used to manufacture any type of automobile interior component desired.

In the illustrated embodiment of the invention, mold 90 forms a portion of an insert molding apparatus. In this regard, mold 90 includes first and second mold halves 92 and 94 that are movable with respect to each other between open and closed positions. When the mold 90 is in a closed position, an article defining cavity 96 is defined between the mold halves 92 and 94 as shown in FIG. 6. The shape of the article defining cavity 96 corresponds to the automobile interior component that is to be manufactured. Mold 90 includes a number of heating units 98 that are used to heat the moldable material that is contained in the article defining cavity 96 during portions of the molding process.

In the illustrated embodiment of the invention, an insert molding process is used to form automobile interior components by the following steps. First, a honeycomb structure having a desired shape is provided. In one example, the honeycomb structure can be shaped in accordance with the shape of the honeycomb structures 60 and 62 that are described above with regard to FIGS. 1-5. Second, the honeycomb structure is positioned at a predetermined position on one of the mold halves 92 and 94. This position corresponds to the location on an automobile interior component that is to be manufactured at which a honeycomb structure is to be located. Positioning the honeycomb structure in this manner allows the automobile interior component to satisfy safety standards as discussed above.

Third, a predetermined amount of a thermoplastic resin, elastomer, or like material is injected into the article defining cavity 96. This causes an automobile interior component to be formed around the honeycomb structure. After the insert molding process is completed, the honeycomb structure is integrally bonded to the automobile interior component. The, the automobile interior component/honeycomb structure assembly is removed from the mold 90.

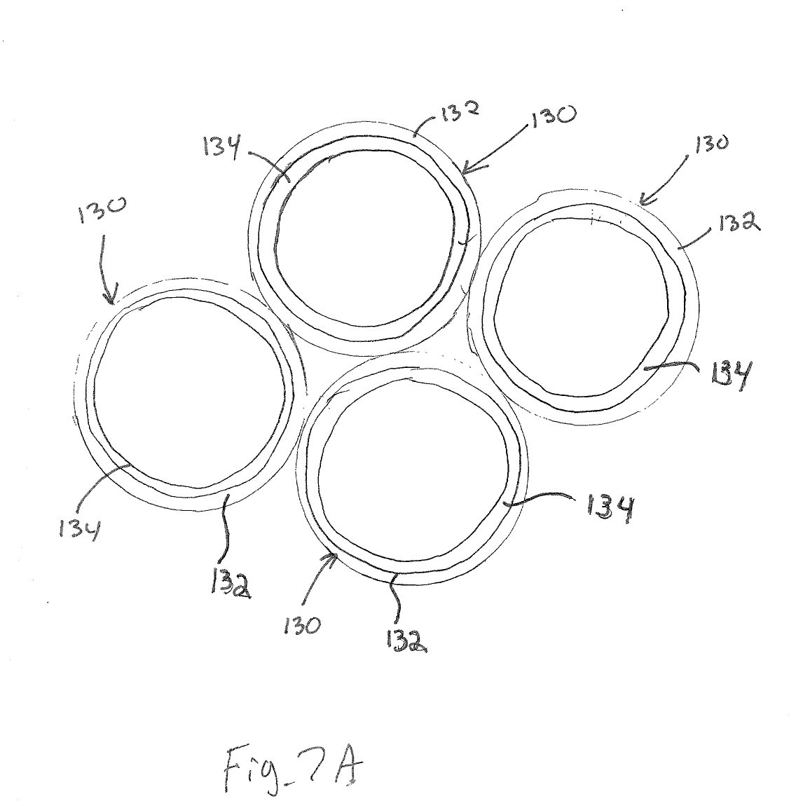

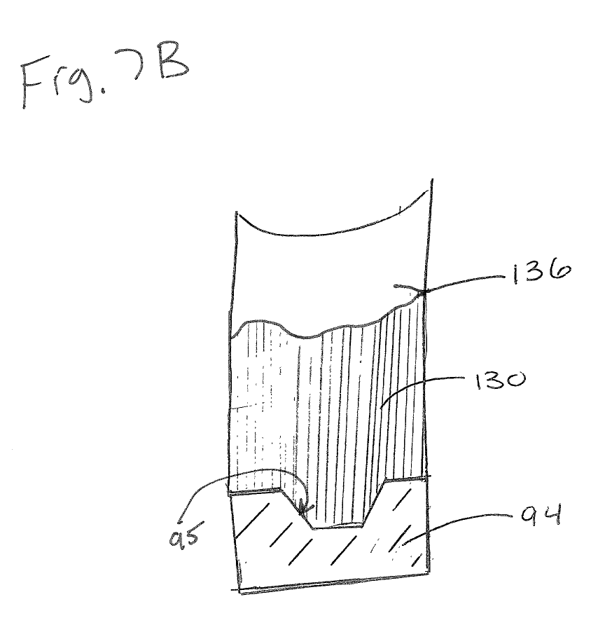

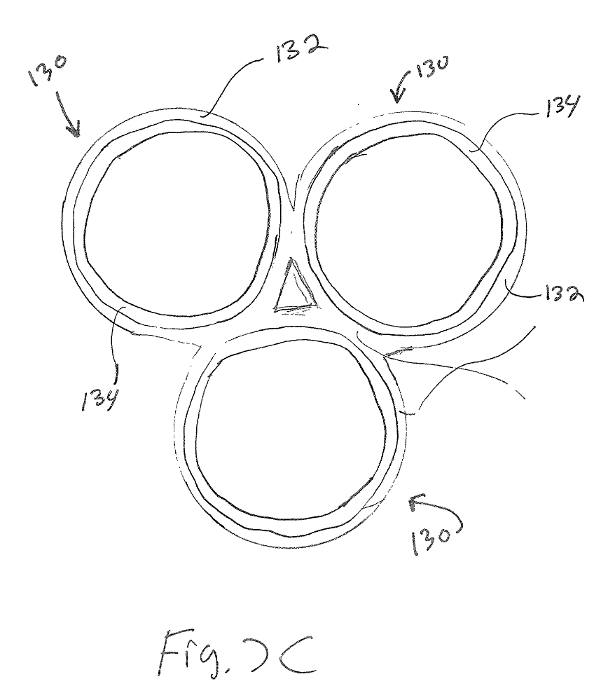

Discussed hereafter with regard to FIGS. 7A-10 is a method for forming a honeycomb structure with a desired shape. Referring to FIG. 7A, a top view of a plurality of separate straw members 130 that are indexed into a shape defining cavity of a mold are shown. Each straw member 130 comprises a central core 134 that is formed from a first thermoplastic material that has a relatively high melting point. An outer layer of a second thermoplastic material 132 surrounds each central core 134 and has a relatively low melting point to allow a plurality of straw members 130 to be joined together and a desired honeycomb structure to be manufactured as discussed in greater detail hereafter.

Referring to FIG. 7B, sectional view of a mold half 94 that includes a shape defining cavity 95 in which a plurality of straws 130 are disposed is shown. The shape of the article defining cavity 95 generally corresponds to the desired shape of one side of the honeycomb structure that is to be formed and affixed to an automobile interior component to enable it to satisfy safety requirements such as, for example, head impact collision standards. The straw members 130 are contained in a holding fixture 136 that allows the straw members 130 to be indexed into general flush contact with the mold half 94 and shape defining cavity 95.

To form one side of the honeycomb structure 60, the mold half 94 is heated to a predetermined temperature, high enough to melt the low temperature material of the straw members outer layer 132, but low enough so as not to melt the high temperature material of the straw members inner core 134. Melting the low temperature outer core 132 in such a manner forms a bond between the straw members after they are cooled. As one example, referring to FIG. 7C, a top view of a plurality of straw members 130 that have been bonded together to form a unitary structure is shown.

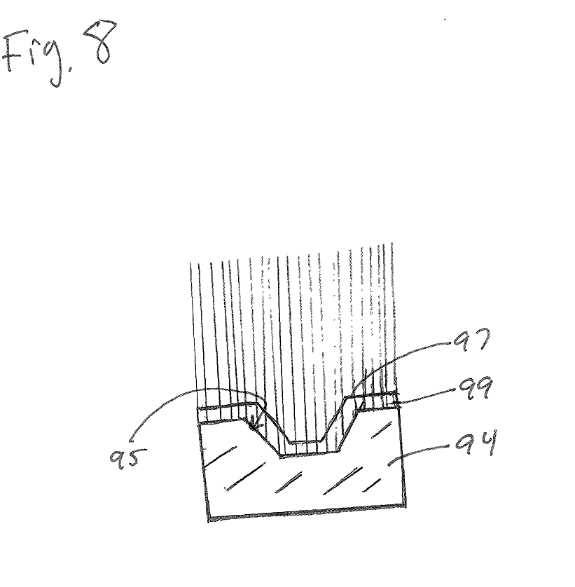

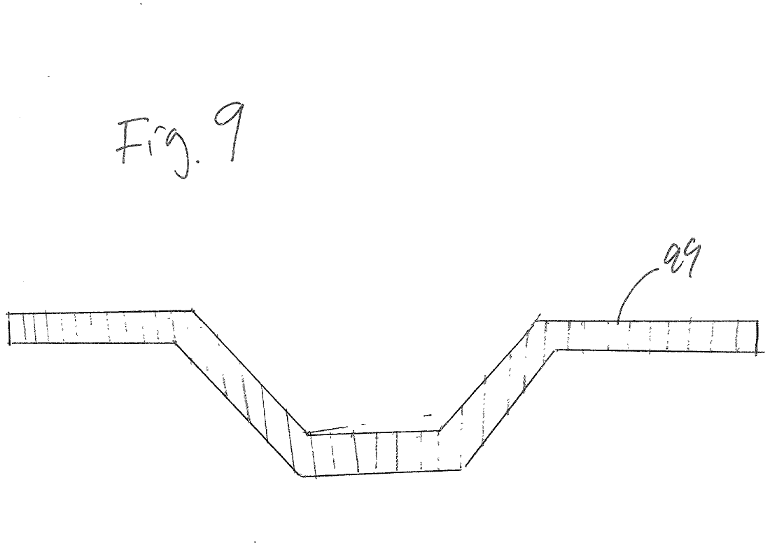

Referring to FIG. 8, a sectional view of a mold half 94, similar to FIG. 7B, showing a cut line 97 through a plurality of indexed straws is shown. This allows a honeycomb structure 99 to be formed, a sectional view of which is shown in FIG. 9. In particular, a cutting utensil, such as a hot knife, hot piano wire or the like, is used to make the cut along line 97 to allow honeycomb structure 99 to be formed. In the illustrated embodiment of the invention, the shape of the cut line generally corresponds to the surface contour of the shape defining cavity 97. This allows, for example, material waste of the bonded straw members 130 to be significantly reduced.

It should be understood that the method for forming a honeycomb structure discussed above with regard to FIGS. 7A-9 is adaptable to be utilized in an in-line manufacturing process for manufacturing automobile interior components. For example, a robot could be utilized to move a formed honeycomb structure from mold half 94 (FIG. 8) to an injection mold apparatus (not shown) that would allow the honeycomb structure to be bonded to an automobile interior component as it is formed.

From the foregoing it will be observed that numerous modifications and variations can be effectuated without departing from the true spirit and scope of the novel concepts of the present invention. It is to be understood that no limitation with respect to the specific embodiments illustrated is intended or should be inferred. The disclosure is intended to cover by the appended claims all such modifications as fall within the scope of the claims when the claims are properly interpreted.

1. A method of manufacturing a honeycomb structure that is to be affixed to a desired location on an automobile interior component to allow the automobile interior component to satisfy safety standards, said method comprising the steps of:
determining the shape of one side of said honeycomb structure to be formed;
forming a shape defining cavity in a mold, the surface contour of said shape defining cavity generally corresponding to the shape of said one side of said honeycomb structure,
indexing a plurality of separate straws members into general flush contact with said shape defining cavity, each one of said straw members including a central core that is formed from a thermoplastic material having a relatively high melting point, each one of said straw members also including an outer layer of thermoplastic material that surrounds said central core and has a relatively low melting point;
heating said mold half to a temperature that melts the outer layer of each of said straw members and then cooling said straw members to cause said straw members to be bonded together and form a unitary structure; and
cutting said group of indexed straws to form a honeycomb structure having a desired shape.

2. The method of claim 1, wherein said group of indexed straws is cut to have generally the same shape as the surface contour of the shape defining cavity of said mold.
